(19) United States
(12) Patent Application Publication
(10) Pub. No.: US 2005/0017842 A1
(43) Pub. Date: Jan. 27, 2005

(54) Adjustment apparatus for adjusting customizable vehicle components

(76) Inventor: Bryan Dematteo, Forest Hills, NY (US)

Correspondence Address: Bryan N. DeMatteo;Apt. 2W, 68-12 Yellowstone Blvd., Forest Hills, NY, 11375, US

(21) Appl. No.: 10/627,937

(22) Filed: Jul. 25, 2003

(51) Int. Cl. G08B 29/00

(52) U.S. Cl. 340/5.72; 701/49; 340/5.61

(57) ABSTRACT

An adjustment apparatus of a vehicle is provided. The apparatus includes at least one customizable vehicle component situated within the vehicle; a receiving arrangement configured to receive identification signals communicated by at least one identification device, the identification device having a position with respect to the vehicle; and a processing arrangement communicatively coupled to the receiving arrangement, the receiving arrangement configured to communicate the identification signals to the processing arrangement; in which the processing arrangement is configured to automatically set a user preference of the customizable vehicle component as a function of the identification signals and as a function of the position of the identification device with respect to the vehicle.

### FIELD OF THE INVENTION

The present invention relates to an adjustment apparatus for adjusting at least one customizable component of a vehicle.

### BACKGROUND INFORMATION

It is known to provide various customizable vehicle components in a vehicle, such as a car, boat, plane, etc. For example, the settings of one or more vehicle seats may be adjusted in accordance with the preferences of a particular vehicle occupant. Some vehicles include “memory preset settings,” which allow a user to recall a certain preset preference for customizable vehicle components. For example, some vehicles include keypad input devices that allow a user to select one of various seat adjustment settings, and a computer of the vehicle then automatically adjusts the seat according to the seat adjustment setting selected by the user. Each of the seat adjustment settings may, for example, be customized to a particular user's preference, so that the seat may be adjusted automatically to his/her liking each time the particular seat adjustment setting is selected. Thus, for example, if the keypad input device allows a user to select one of four seat adjustment settings, each member of a four person family (e.g., father, mother, son, and daughter) may customize and adjust a respective one of the four seat adjustment settings to his/or her preferences.

U.S. Published patent application No. 20020118579 to Lucy et al. describes a method for automatically setting memory preferences from a remote vehicle entry device. As characterized, the remote memory preference system utilizes existing passive or active remote entry devices. Memory preference settings include driver's seat position, mirror positions and radio station presets. Once these settings are adjusted by a primary vehicle user, they are stored in a memory location in the vehicle either automatically or when a memory button on the remote entry device is depressed by the user. Settings may then be later recalled either automatically by activating the remote entry device or when a recall button on the remote entry device is depressed by the user. The system may also employ a shift register system, which would automatically store current and previous memory preference settings.

In some situations, the entry point of an authorized user into the vehicle is important in determining which of the customizable vehicle components to adjust. For example, if the authorized user intends to sit in the front passenger seat, only the passenger side seat should be adjusted, not the driver's side seat. Alternatively, if the authorized user intends to sit in the driver's seat, only the driver's seat should be adjusted. This may be especially important if two authorized users are to enter the vehicle at the same time. For example, if the father is to enter the driver's side of the vehicle and the mother is to enter the passenger side of the vehicle. In this situation, only the driver's side customizable vehicle components (e.g., the driver's side seat) should be set to the father's preferences and only the passenger side customizable vehicle components (e.g., the passenger side seat) should be set to the mother's preferences.

It may also be important to determine whether an authorized user intends to enter the vehicle at all. For example, customizable vehicle components (e.g., vehicle seats) should not be adjusted unless an authorized user actually intends to enter the vehicle. For example, if the father just happens to walk next to the vehicle while throwing out the garbage, the customizable vehicle components should not be adjusted, since the father obviously does not intend to enter the vehicle.

However, it is believed that the method of U.S. Published patent application No. 20020118579 does not provide any method or apparatus for determining which of a plurality of doors of the vehicle a user intends to enter, nor does this Published patent application provide any method or apparatus for determining whether a user intends to enter the vehicle.

### SUMMARY OF THE INVENTION

It is an object of the present invention to overcome the disadvantages of prior art adjustment apparatuses described above. For this purpose, the present invention provides an adjustment apparatus of a vehicle, the apparatus including at least one customizable vehicle component situated within the vehicle; a receiving arrangement configured to receive identification signals communicated by at least one identification device, the identification device having a position with respect to the vehicle; and a processing arrangement communicatively coupled to the receiving arrangement, the receiving arrangement configured to communicate the identification signals to the processing arrangement; in which the processing arrangement is configured to automatically set a user preference of the customizable vehicle component as a function of the identification signals and as a function of the position of the identification device with respect to the vehicle.

It is another object of the present invention to provide the adjustment apparatus described above, in which the identification device includes a key and an electronic circuit arranged on the key, the receiving arrangement including a key reading circuit configured to receive the identification signals from the electronic circuit arranged on the key when the key is inserted into a keyhole receptacle of the vehicle.

It is still another object of the present invention to provide the adjustment apparatus described above, in which the vehicle includes a plurality of keyhole receptacles, the processing arrangement being configured to automatically set the user preference of the customizable vehicle component as a function of which of the keyhole receptacles the key is inserted into.

It is yet another object of the present invention to provide the adjustment apparatus described above, in which the identification device includes a transponder, and the receiving arrangement is configured to receive the identification signals wirelessly from the transponder.

It is yet another object of the present invention to provide the adjustment apparatus described above, in which the identification device includes a passive transponder, the adjustment apparatus further comprising an interrogation circuit configured to interrogate the passive transponder to cause the passive transponder to wirelessly communicate the identification signals to the receiving arrangement.

It is still another object of the present invention to provide the adjustment apparatus described above, in which the interrogation circuit is configured to interrogate the passive transponder when a door opening device is activated.

It is still another object of the present invention to provide the adjustment apparatus described above, in which the interrogation circuit is configured to interrogate the passive transponder when a key is inserted into a keyhole receptacle of the vehicle.

It is yet another object of the present invention to provide the adjustment apparatus described above, in which the processing arrangement is configured to automatically set the user preference of the customizable vehicle component as a function of a strength of the identification signals wirelessly communicated by the transponder.

It is still another object of the present invention to provide the adjustment apparatus described above, in which the receiving arrangement includes a plurality of receiver circuits arranged in the vehicle, the processing arrangement being configured to automatically set the user preference of the customizable vehicle component as a function of which of the receiver circuits receives the identification signals wirelessly communicated by the transponder.

It is yet another object of the present invention to provide the adjustment apparatus described above, in which the processing arrangement is configured to automatically set the user preference of the customizable vehicle component as a function of a strength of the identification signals wirelessly communicated by the transponder.

It is still another object of the present invention to provide the adjustment apparatus described above, in which the receiver circuits of the receiving arrangement include respective directional limiting arrangements configured to limit locations from which the receiver circuits receive the identification signals wirelessly communicated by the transponder.

It is yet another object of the present invention to provide the adjustment apparatus described above, in which the directional limiting arrangements include respective directional antenna arrangements configured to receive the identification signals wirelessly communicated by the transponder.

It is still another object of the present invention to provide the adjustment apparatus described above, in which the processing arrangement is configured to automatically set the user preference of the customizable vehicle component only if at least one external event indicates that a user of the identification device intends to enter the vehicle.

It is yet another object of the present invention to provide the adjustment apparatus described above, in which the external event includes the activation of an active transponder to communicate a wireless entry intent signal, the receiving arrangement being configured to detect the wireless entry intent signal.

It is still another object of the present invention to provide the adjustment apparatus described above, in which the external event includes an insertion of a key into a keyhole receptacle, and the adjustment apparatus further comprises a key insertion detection circuit configured to detect the insertion of the key into the keyhole receptacle, the key insertion detection circuit being further configured to communicate an insertion detect signal to the processing arrangement if the key insertion detection circuit detects the insertion of the key into the keyhole receptacle.

It is yet another object of the present invention to provide the adjustment apparatus described above, in which the vehicle includes a plurality of doors and at least one door opening device configured to open at least one of the doors, and the external event includes an activation of the door opening device, the adjustment apparatus further comprising an activation detection circuit configured to detect the activation of the door opening device, the activation detection circuit being further configured to communicate an activation detect signal to the processing arrangement if the activation detection circuit detects the activation of the door opening device.

### BRIEF DESCRIPTION OF THE DRAWINGS

FIG. 1 is a block diagram of an exemplary adjustment apparatus according to the present invention.

FIG. 2 is a block diagram of an exemplary processing arrangement according to the present invention.

FIG. 3 is an illustration showing an exemplary identification device in the form of a key identification arrangement and an exemplary receiving arrangement according to the present invention.

FIG. 4a and 4b are block diagrams of exemplary passive transponder identification devices and receiving arrangements, respectively, according to the present invention.

FIG. 5 is a block diagram of an active transponder and receiver arrangement according to the present invention.

FIG. 6 is an illustration of an exemplary vehicle according to the present invention.

FIG. 7 illustrates an exemplary vehicle and door activation device according to the present invention.

### DETAILED DESCRIPTION

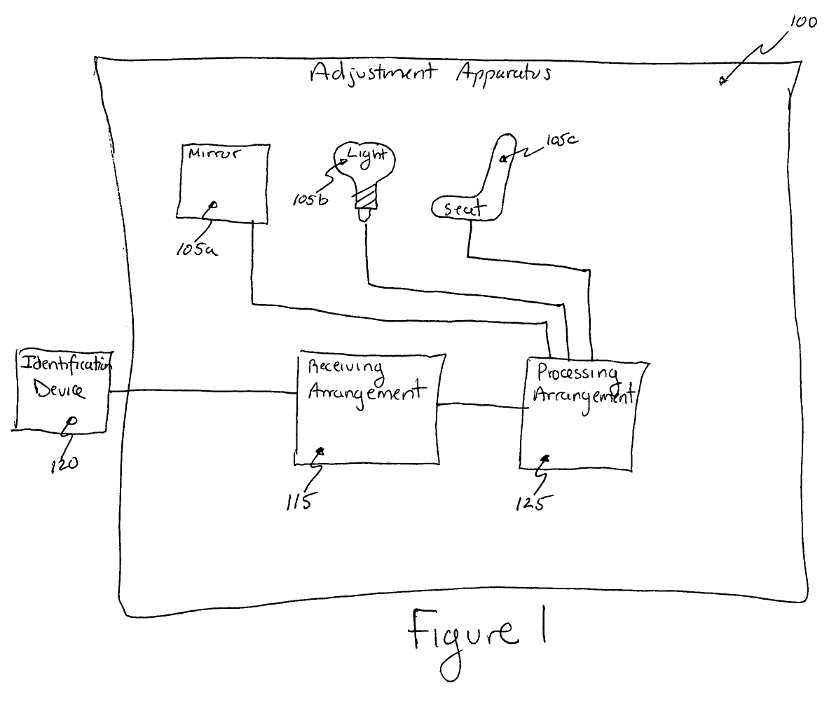

Referring now to FIG. 1, there is seen a first exemplary adjustment apparatus 100 of a vehicle 110 according to the present invention. Adjustment apparatus 100 includes customizable vehicle components 105a, 105b, 105c situated within the vehicle 110 (e.g., car, boat, plane, etc.), a receiving arrangement 115 configured to receive identification signals communicated by at least one identification device 120, and a processing arrangement 125 communicatively coupled to receiving arrangement 115 and customizable vehicle components 105a, 105b, 105c.

As shown in FIG. 1, customizable vehicle components 105a, 105b, 105c include an adjustable mirror 105a, an adjustable light 105b, and an adjustable seat 105c. However, it should be appreciated that vehicle 110 may include any number of customizable components. Customizable components may include, for example, customizable seats, customizable lights, customizable radio station settings, customizable environmental settings, customizable cabin temperature, customizable mirror settings, customizable, and/or any other component configured to be customized to a user's preference.

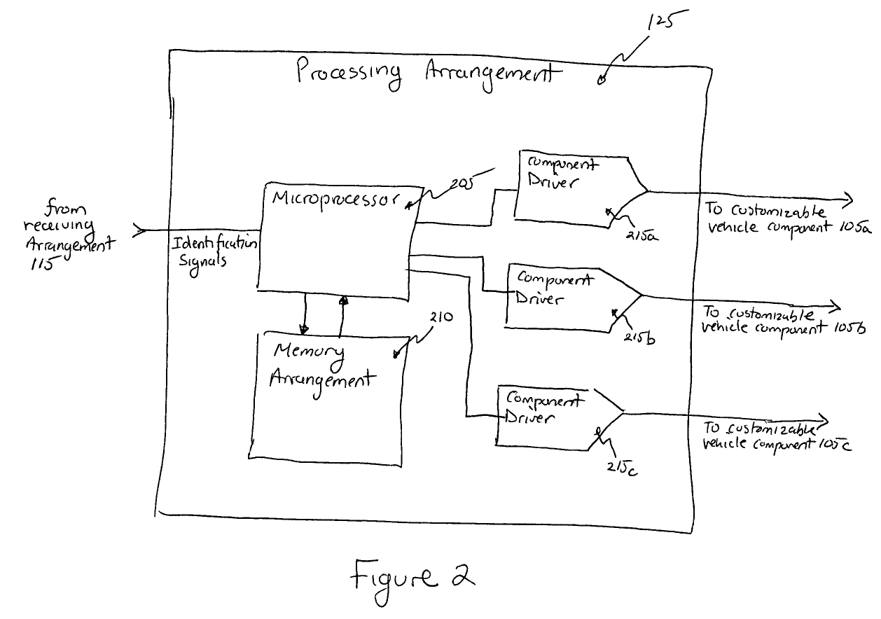

Receiving arrangement 115 is configured to receive identification signals communicated by at least one identification device 120, and then to communicate the identification signals to processing arrangement 125. Referring now to FIG. 2, there is seen an exemplary processing arrangement 125 according to the present invention. Processing arrangement 125 includes a microprocessor 205 to receive the identification signals from receiving arrangement 115, a memory arrangement 210 (e.g., Read-Only Memory (ROM), Random Access Memory (RAM), EEPROM, EPROM, flash, hardrive, disk, etc.) to store a software program to be executed on microprocessor 205, and component drivers 215a, 215b, 215c assigned to customizable vehicle components 105a, 105b, 105c. Component drivers 215a, 215b, 215c are electrically and communicatively coupled to the microprocessor 205 and configured to respectively control and adjust customizable vehicle components 105a, 105b, 105c in accordance command signals communicated by microprocessor 205. It should be appreciated that, although FIG. 2 illustrates only three component drivers 215a, 215b, 215c, processing arrangement 125 may include any number of component drivers for setting, controlling and/or adjusting any number of customizable vehicle components.

In addition to storing a software program for execution on microprocessor 205 (e.g., a software program to cause processing arrangement 125 to perform the functions described herein), memory arrangement 210 may store various profiles of user preferences, which characterize preferred settings and/or adjustments of customizable vehicle components 105a, 105b, 105c (e.g., mirror 105a, light 105b, and seat 105c). Each of the profiles of user preferences may be set-up, edited, and/or created by one or more authorized users of vehicle 110. Thus, with respect to a hypothetical and exemplary family of four (e.g., a father, a mother, a son, and a daughter), memory arrangement 210 may store, for example, four profiles of user preferences associated with the respective family members. The profiles contain information that permits microprocessor 205 to adjust one or more of customizable vehicle components 105a, 105b, 105c in accordance with the respective preferences of the family members (e.g., a father, a mother, a son, and a daughter). Thus, for example, a profile assigned to the father may, for example, contain information that would permit microprocessor 205 to automatically adjust mirror 105a, light 105b, and seat 105c to the preferences of the father, without the father having to manually set such preferences, the adjustments being performed via respective component drivers 215a, 215b, 215c. Processing arrangement 125 selects a particular profile from the profiles of user preferences in accordance with the identification signals communicated by receiving arrangement 115, in a manner more filly described below.

It should be appreciated that, although the above exemplary embodiment discusses adjustment arrangement 100 with respect to a four person family, memory arrangement 210 may store any number of profiles associated with any number of authorized users of vehicle 110. In this manner, it will be appreciated that the present invention is not intended to be limited by either the number of authorized users of the vehicles or the number of profiles of user preferences stored in memory arrangement 210.

The identification signals communicated by receiving arrangement 115 to processing arrangement 125 contain information identifying which of a plurality of identification devices 120 are communicating the identification signals. For this purpose, each of identification devices 120 is configured to communicate unique identification signals containing unique information. The unique identification signals are then used by processing arrangement 125 to select the appropriate profile containing user preferences. Thus, referring back to the hypothetical and exemplary family of four individuals (e.g., a father, a mother, a son, and a daughter), if the family members are assigned and given respective identification devices 120, and the father's identification device 120 communicates its unique identification signals to receiving arrangement 115, processing arrangement 125 will select the profile of user preferences associated with the father. Of course, it will be appreciated that processing arrangement 125 may also be configured to select other profiles of user preferences when other identification devices 120 communicate unique identification signals. For example, processing arrangement 125 may select the daughter's profile of preferences if the daughter's identification device 120 communicates its identification signals. It should also be appreciated that memory arrangement 210 may include any number of profiles of user preferences for settings and/or adjustments of any number of customizable vehicle components 105.

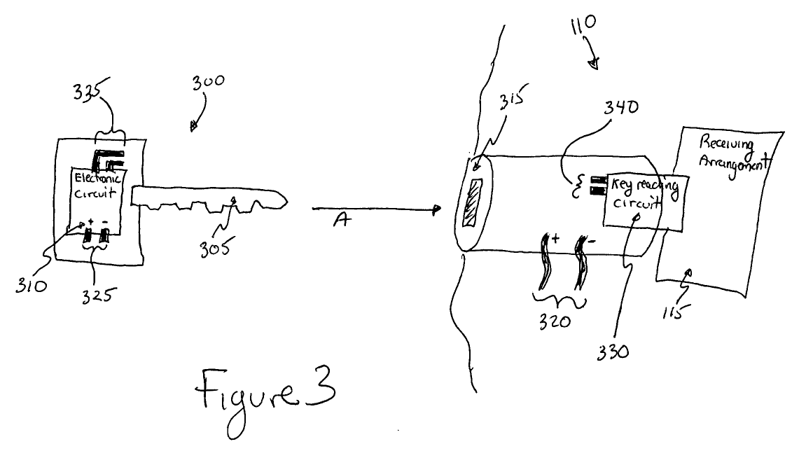

Identification device 120 includes any arrangement, mechanism, and/or device configured to communicate identification signals to receiving arrangement 115. Referring now to FIG. 3, there is seen an exemplary identification device 120 in the form of a key identification arrangement 300 and a receiving arrangement 115 including a key reading circuit 330, according to the present invention. Key identification arrangement 300 includes a key 305 to permit an authorized user of the vehicle to gain access to the vehicle and an electronic circuit 310 arranged on key 305 to communicate the unique identification signals. To gain access to vehicle 110, an authorized user inserts key 305 of key identification arrangement 300 into a keyhole receptacle of vehicle 110 by inserting along direction A. Then, the authorized user may turn the key 305 of key identification arrangement 300 (either clockwise or counterclockwise) to gain access to vehicle 110. Electronic circuit 310 may contain its own power source (not shown) or may receive power from appropriately place power leads 320 situated in the keyhole receptacle 315 of vehicle 110. In this manner, electronic circuit 310 may include power receiving leads 325 configured to contact power leads 320 of keyhole receptacle 315 when key 305 of key identification arrangement 300 is inserted into keyhole receptacle 315. Once inserted into keyhole receptacle 315, key reading circuit 330 of receiving arrangement 115 may retrieve the identification signals communicated by electronic circuit 310 of key identification arrangement 300. For this purpose, key reading circuit 330 may include, for example, appropriately placed data wires 340 properly situated within keyhole receptacle 315 and configured to electrically contact associated data communication leads 335 of electronic circuit 310.

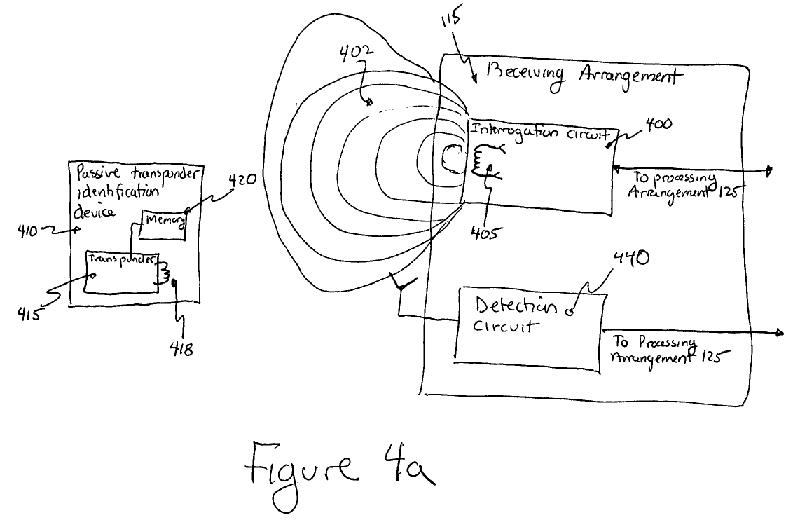

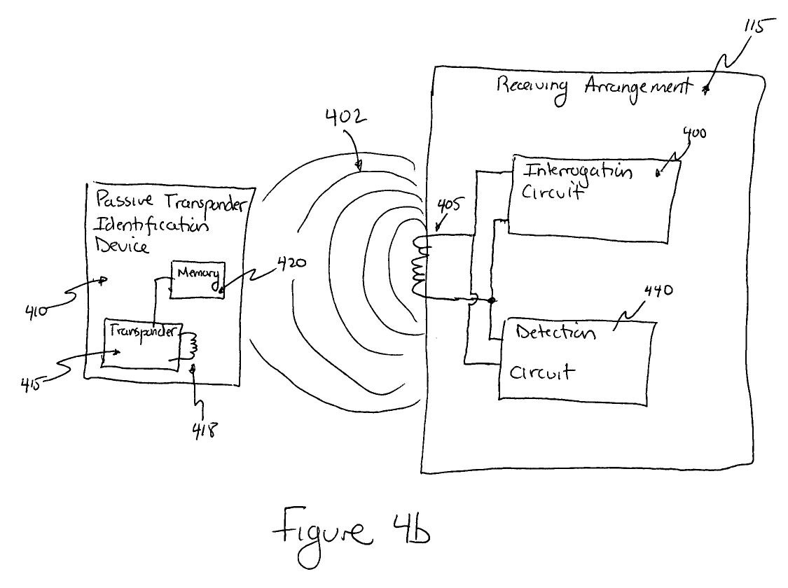

Referring now to FIG. 4a, there is seen another exemplary identification device 120 and receiving arrangement 115 according to the present invention. In this exemplary embodiment, receiving arrangement 115 is configured to detect the presence of a passive transponder identification device 410 associated with a particular associated and/or authorized user of the vehicle. For this purpose, receiving arrangement 115 includes an interrogation circuit 400 configured to generate a magnetic field 402 of a certain frequency (i.e., interrogates for a transponder) via an inductor coil 405 situated in interrogation circuit 400. A transponder 415 of transponder identification device 410 located in the vicinity of vehicle 110 includes a coil 418, and the magnetic field 402 produced by inductor coil 405 of interrogation circuit 400 causes a voltage to be induced across the coil 418 of transponder 415. In a known manner, transponder identification device 410 extracts electrical energy from the induced voltage, and then causes current to either flow through coil 418 or not flow in accordance with identification signals stored in a memory 420 of transponder identification device 410. The current flow through transponder coil 418 causes dips in the magnetic field 402 produced by the transmission coil 405 of interrogation circuit 400. Receiving arrangement 115 may then detect the dips in the magnetic field via detection circuit 440 wirelessly and, as such, extract the identification signals stored in transponder 415 of transponder identification device 410. Such passive transponder systems are well known and referred to in, for example, U.S. Pat. No. 5,382,952 to Miller, U.S. Pat. No. 4,818,855 to Mongeon et al., and U.S. Pat. No. 4,630,044 to Polzer. In this manner, each of the transponder identification devices 410 assigned to the various authorized users of vehicle 110 may include separate and unique identification signal information, which effectively permits processing arrangement 125 to uniquely identify a particular transponder identification device 410 and, as such a particular authorized user. Thus, in the four-person family example described above, each of the father, mother, son, and daughter may carry with him/her a separate passive transponder identification device 410, each of which transmits unique identification signals in response to a magnetic field interrogation generated by inductor coil 405 of interrogation circuit 400. The microprocessor 205 of processing arrangement 115 may then select the appropriate profile of user preferences in accordance with the identification signals transmitted by a detected passive transponder identification device 410. Thus, for example, if the daughter approached vehicle 110 with her assigned passive transponder identification device 410, vehicle 110 would detect the identification signal information contained in transponder 415 of transponder identification device 410 and cause the profile associated with the daughter's preferences to be automatically selected by processing arrangement 125.

It should be appreciated that the receiver coil (not shown) of detection circuit 440 may comprise the same inductor coil 405 of interrogation circuit 400. Referring now to FIG. 4b, there is seen detection circuit 440 of receiving arrangement 115 and interrogation circuit 400 sharing the same inductor coil 405. In this manner, interrogation circuit 400 may interrogate passive transponder identification device 410 while detection circuit 440 simultaneously (or a short time thereafter) receives the identification signals wirelessly transmitted by passive transponder identification device 410.

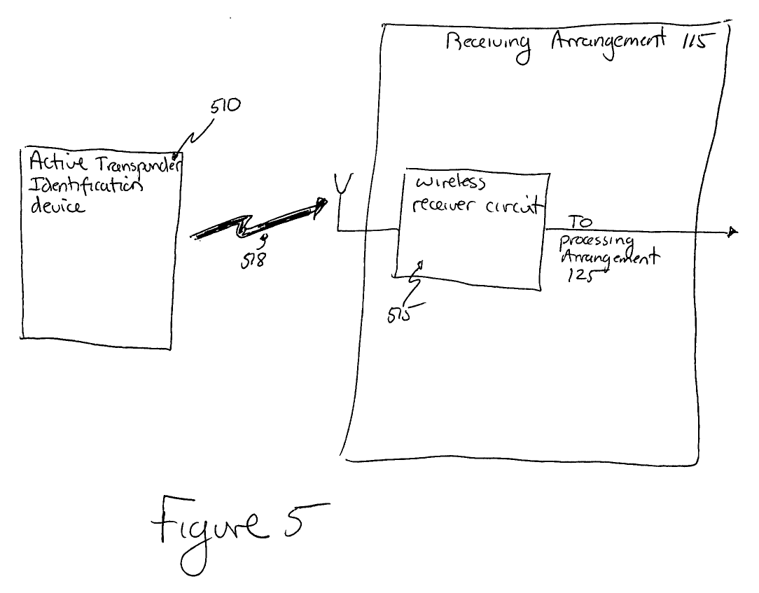

Referring now to FIG. 5, there is seen yet another exemplary identification device 120 and receiving arrangement 115 according to the present invention. In this exemplary embodiment, receiving arrangement 115 is configured to detect the presence of an active transponder identification device 510 associated with a particular associated and/or authorized user of vehicle 110. In this exemplary embodiment, receiving arrangement 115 includes a wireless receiver circuit 515 configured to detect a wireless signal 518 communicated by active transponder identification device 510. Active transponder identification device 510 may include, for example, a remote battery operated transponder for identifying a particular user of vehicle 110 and/or for unlocking/locking doors of vehicle 110. In this embodiment, each of the associated and/or authorized users of vehicle 110 would receive a separate active transponder identification device 510 for unlocking and locking the vehicle's doors and/or for turning off and on an alarm system for the vehicle. Each of active transponder identification devices 510 assigned to the associated and/or authorized users would wirelessly transmit the identification signals along with, for example, data required to unlock and lock the vehicle's doors and/or to turn off and on an alarm system of vehicle 110, if the assigned user operates active transponder identification device 510. Thus, for example, if the daughter approached vehicle 110 with her assigned active transponder identification device 510, she may use active transponder identification device 510, for example, to unlock the doors of vehicle 110. In so doing, the identification signals assigned to the daughter's transponder are wirelessly transmitted to vehicle 110. In this manner, vehicle 110 may cause the doors to be locked/unlocked and may cause processing arrangement 125 to automatically select the profile of preferences assigned to the daughter in accordance with the identification signals transmitted by the daughter's active transponder identification device 510.

In some situations, the entry point of an authorized user into vehicle 110 is important in determining which of the customizable vehicle components 105a, 105b, 105c to adjust. For example, if the authorized user intends to sit in the front passenger seat, processing arrangement 125 should adjust only passenger side seat 105c, but not, for example, the driver's side seat. Alternatively, if the authorized user intends to sit in the driver's seat, processing arrangement 125 should adjust, for example, only the driver's seat. This may be especially important if two authorized users are to enter vehicle 110 at the same time. For example, if the father is to enter the driver's side of vehicle 110 and the mother is to enter the passenger side of vehicle 110. In this situation, processing arrangement 125 should set and/or adjust the driver's side customizable vehicle components 105a, 105b, 105c to the father's preferences and should set and/or adjust the passenger side customizable vehicle components 105a, 105b, 105c to the mother's preferences.

For this purpose, processing arrangement 125 is configured to automatically set a user preference of the customizable vehicle component as a function of the position of an authorized user with respect to the vehicle and/or a position of the identification device with respect to the vehicle. In this manner, for example, if the daughter (of the four person hypothetical and exemplary family described above) is on the driver's side of vehicle 110 when her identification device 120 communicates the identification signals, processing arrangement 125 may detect at least one attribute concerning her position, for example, processing arrangement 125 may detect that the daughter's identification device 120 (as well as the daughter herself) are on the driver's side of the car. With such information, it may be presumed, for example, that the daughter intends to enter vehicle 110 on the driver's side of vehicle 110 and, as such, processing arrangement 125 may set and/or adjust only the driver's side customizable vehicle components 105a, 105b, 105c to the daughter's preferences. For example, processing arrangement 125 may set and/or adjust only the driver's side mirror 105a, only the driver's side light 105b, and/or only the driver's side seat 105c to the daughter's preferences. It should be appreciated that processing arrangement 125 may also be configured to detect other attributes of the position of identification device 120 relative to vehicle 110, for example, when identification device 120 communicates the identification signals. In this manner, for example, processing arrangement 125 may detect whether identification device 120 is situated near the passenger side rear of the vehicle (e.g., indicating the authorized user intends to enter the rear passenger side door of vehicle 110) or, for example, the driver's side rear of vehicle 110 (e.g., indicating the authorized user intends to enter the rear driver's side door of vehicle 110). It should also be appreciated that the position detection function may be performed by a circuit separate and apart from processing arrangement 125. For example, the determination of position of the authorized user and/or the identification device 120 may be performed by an Application Specific Integrated Circuit (ASIC), and/or an otherwise separate and distinct Integrated Circuit (IC).

With respect to the exemplary identification device 120 and receiving arrangement 115 of FIG. 3, processing arrangement 125 may determine at least a rough position of the authorized user and/or the identification device 120 in accordance with which of a plurality of keyhole receptacles key 305 of key identification arrangement 300 is inserted into. Thus, for example, if vehicle 110 includes two keyhole receptacles (i.e., one on the driver's side of vehicle 110 and one on the passenger's side of vehicle 110), and key identification arrangement 300 is inserted into the driver's side keyhole receptacle, the identification signals are communicated from the driver's side keyhole receptacle to processing arrangement 125, thereby simultaneously notifying processing arrangement 125 that key identification arrangement 300 is located on the driver's side of vehicle 110 (and, as such, that the user holding key identification arrangement 300 may intends to enter vehicle 110 on the driver's side of vehicle 110). Processing arrangement 125 would then use the identification signals (i.e., to choose the appropriate profile of user preferences) to set and/or adjust only the driver's side customizable vehicle components 105a, 105b, 105c in accordance with the profile of preferences assigned to the authorized user and/or the identification device 120. Alternatively, for example, if key identification arrangement 300 is inserted into the passenger's side keyhole receptacle, the identification signals are communicated from the passenger side keyhole receptacle to processing arrangement 125, thereby simultaneously notifying processing arrangement 125 that key identification arrangement 300 is located on the passenger's side of vehicle 110 (and, as such, that the user holding key identification arrangement 300 may intend to enter vehicle 110 on the passenger's side of vehicle 110). Processing arrangement 125 would then use the identification signals (i.e., to choose the appropriate profile of user preferences) to set and/or adjust only the passenger's side customizable vehicle components 105a, 105b, 105c in accordance with the profile of preferences assigned to the authorized user and/or the identification device 120. It should be appreciated that, although the above hypothetical and exemplary situation describes only two keyhole receptacles (i.e., one on the driver's side of vehicle 110 and one on the passenger's side of vehicle 110), vehicle 110 may include any number of keyhole receptacles, and processing arrangement may determine at least a rough position of the authorized user and/or the identification device 120 in accordance with which of the keyhole receptacles key 305 of key identification arrangement 300 is inserted into. For example, vehicle 110 may include four keyhole receptacles (e.g., one for the front driver's side door, one for the rear driver's side door, one for the front passenger's side, and one for the rear passenger side door).

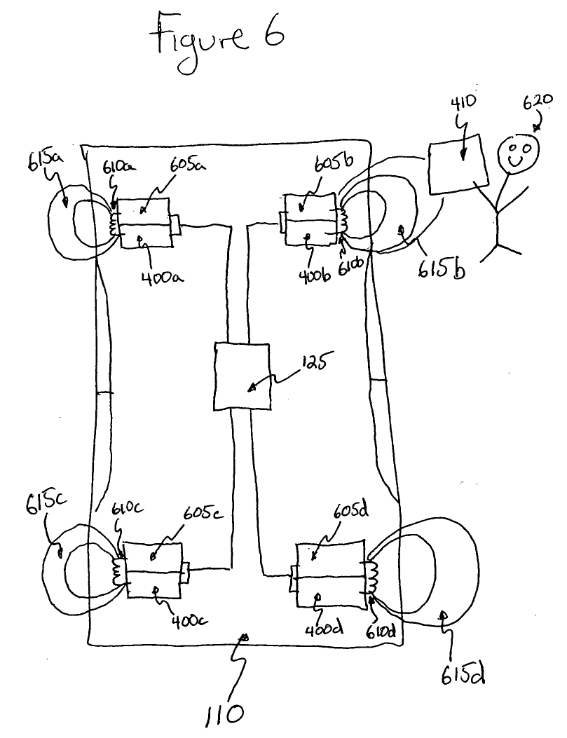

With respect to the exemplary identification device 120 and receiving arrangements 115 of FIGS. 4a and 4b, receiving arrangement 115 may include a plurality of receiver circuits arranged in vehicle 110, and processing arrangement 125 may determine at least a rough position of the authorized user and/or the identification device 120 in accordance with which of the receiver circuits receives the identification signals wirelessly communicated by the passive transponder identification device 410. Referring now to FIG. 6, there is seen a top view of vehicle 110 having four separate receiver circuits 605a, 605b, 605c, 605d and four separate interrogation circuits 400a, 400b, 400c, 440d sharing respective inductive coils 610a, 610b, 610c, 610d. In this exemplary embodiment, the magnetic fields 615a, 615b, 615c, 615d produced by respective interrogation circuits 400a, 400b, 400c, 440d are only strong enough to detect a passive transponder identification device 410 in close proximity to respective inductive coils 610a, 610b, 610c, 610d. In the exemplary embodiment of FIG. 6, a user 620 holding passive transponder identification device 410 is located near the front passenger's side of vehicle 110 when interrogation circuit 400b, which is located and assigned to the front passenger side door, interrogates passive transponder identification device 410. In this manner, passive transponder identification device 410 magnetically couples with interrogation circuit 400b, so that the identification signals communicated by passive transponder identification device 410 may be detected by receiver circuit 605b. Thus, when receiver circuit 605b transmits the identification signals to processing arrangement 125, processing arrangement 125 is simultaneously notified that passive transponder identification device 410 is located near the front driver's side of vehicle 110 (and, as such, that the user holding passive transponder identification device 410 may intend to enter vehicle 110 from the front passenger side of vehicle 110). It should also be appreciated that more than one of receiver circuits 605a, 605b, 605c, 605d may receive the identification signals from passive transponder identification device 410. In this manner, processing arrangement 125 may determine at least a rough location of authorized user 620 and/or passive transponder identification device 410 in accordance with the signal strength of the identification signals received by those of the receiver circuits 605a, 605b, 605c, 605d receiving the identification signals. I.e., processing arrangement 125 may presume that authorized user 620 and/or passive transponder identification device 410 is located near the receiver circuit 605a, 605b, 605c, 605d receiving the identification signals with the highest signal power. It should also be appreciated that inductive coils 610a, 610b, 610c, 610d may include respective directional antennas (not shown) to limit the propagation in certain directions of the magnetic fields 615a, 615b, 615c, 615d produced by interrogation circuits 400a, 400b, 400c, 440d. In this manner, it may be better ensured that only the appropriate receiver circuits 605a, 605b, 605c, 605d will receive the identification signals. Thus, for example, the directional antennas may be employed to prevent the magnetic fields 615a, 615b, 615c, 615d produced by interrogation circuits 400a, 400b, 400c, 440d from overlapping with magnetic filed 400b, so that, for example, if authorized user 620 and/or passive transponder identification device 410 is located near the front passenger side of vehicle 110, only receiver circuit 605b will receive the identification signals. This may better ensure an accurate reading and/or determination by processing arrangement 125 of the position of authorized user 620 and/or passive transponder identification device 410.

In some situations, it may be important to determine whether an authorized user intends to enter vehicle 110. For example, in at least one exemplary embodiment of the present invention, customizable vehicle components 105a, 105b, 105c should not be adjusted unless an authorized user actually intends to enter vehicle 110. For example, if the son (of the hypothetical and exemplary four person family described above) just happens to walk next to vehicle 110 while throwing out the garbage, customizable vehicle components 105a, 105b, 105c should not be adjusted, since the son obviously does not intend to enter vehicle 110. As such, according to another exemplary embodiment of the present invention, processing arrangement 125 is configured to automatically set the user preference of the customizable vehicle components 105a, 105b, 105c only if at least one external event indicates that the authorized user intends to enter the vehicle. The external event may include any event that even remotely indicates whether the user intends to enter the vehicle.

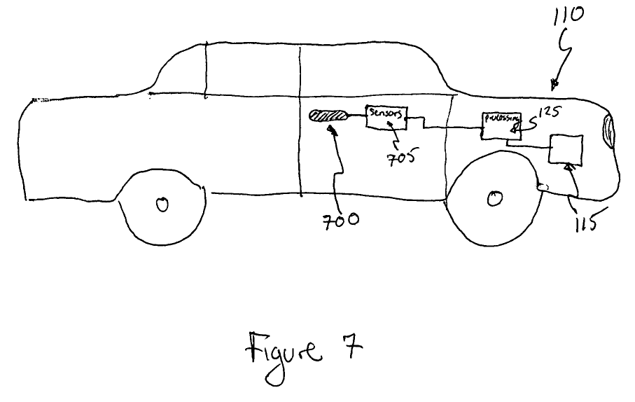

For example, referring to FIG. 7, the external event may include the opening of a door activation device 700 of vehicle 110, such as a door handle of vehicle 110. Sensors 705 may be situated near the door activation device 700, for example, a door handle 700, to detect activation of the door handle and communicate signals to processing arrangement 125 if activation of the door activation device 700, e.g., door handle 700, is detected. In this manner, processing arrangement 125 would automatically set the user preference of the customizable vehicle components 105a, 105b, 105c only if the signals communicated by sensors 705 indicate that the door handle 700 has been (or is about to be) activated.

Or, for example, the external event may include a signal communicated by a transponder identification device 120 indicating the user's intent to enter the vehicle (e.g., if the user unlocks the doors of the vehicle using his/her identification device, such as active transponder identification device 510). With respect to the exemplary embodiment of FIG. 3, for example, the external event may be the insertion of key 305 of key identification arrangement 300 into a keyhole receptacle. In this manner, processing arrangement 125 may receive the appropriate identification signals from key reading circuit 330 of receiving arrangement 115, and an indication of the user's intent to enter vehicle 110 may be provided by the same identification signals (i.e., the same external event) (i.e., the insertion of key 305 of key identification arrangement 300 into a keyhole receptacle and the transmission of identification signals).

It should be appreciated that, although the above-described exemplary embodiments of the present invention refer to two manners of detecting the external event indicating that the authorized user intends to enter the vehicle, the present invention is not intended to be limited by the manner in which the user's intent to enter vehicle 110 is detected. As such, the present invention contemplates and intends to include all manners, devices, mechanisms, etc. for detecting (or guessing) the user's intent to enter vehicle 110.

1. An adjustment apparatus of a vehicle, the apparatus comprising:
at least one customizable vehicle component situated within the vehicle;
a receiving arrangement configured to receive identification signals communicated by at least one identification device, the identification device having a position with respect to the vehicle; and
a processing arrangement communicatively coupled to the receiving arrangement, the receiving arrangement configured to communicate the identification signals to the processing arrangement;
wherein the processing arrangement is configured to automatically set a user preference of the customizable vehicle component as a function of the identification signals and as a function of the position of the identification device with respect to the vehicle.

2. The adjustment apparatus of claim 1, wherein the identification device includes a key and an electronic circuit arranged on the key, the receiving arrangement including a key reading circuit configured to receive the identification signals from the electronic circuit arranged on the key when the key is inserted into a keyhole receptacle of the vehicle.

3. The adjustment apparatus of claim 2, wherein the vehicle includes a plurality of keyhole receptacles, the processing arrangement being configured to automatically set the user preference of the customizable vehicle component as a function of which of the keyhole receptacles the key is inserted into.

4. The adjustment apparatus of claim 1, wherein the identification device includes a transponder, and the receiving arrangement is configured to receive the identification signals wirelessly from the transponder.

5. The adjustment apparatus of claim 4, wherein the identification device includes a passive transponder, the adjustment apparatus further comprising an interrogation circuit configured to interrogate the passive transponder to cause the passive transponder to wirelessly communicate the identification signals to the receiving arrangement.

6. The adjustment apparatus of claim 5, wherein the interrogation circuit is configured to interrogate the passive transponder when a door opening device is activated.

7. The adjustment apparatus of claim 5, wherein the interrogation circuit is configured to interrogate the passive transponder when a key is inserted into a keyhole receptacle of the vehicle.

8. The adjustment apparatus of claim 4, wherein the processing arrangement is configured to automatically set the user preference of the customizable vehicle component as a function of a strength of the identification signals wirelessly communicated by the transponder.

9. The adjustment apparatus of claim 4, wherein the receiving arrangement includes a plurality of receiver circuits arranged in the vehicle, the processing arrangement being configured to automatically set the user preference of the customizable vehicle component as a function of which of the receiver circuits receives the identification signals wirelessly communicated by the transponder.

10. The adjustment apparatus of claim 9, wherein the processing arrangement is configured to automatically set the user preference of the customizable vehicle component as a function of a strength of the identification signals wirelessly communicated by the transponder.

11. The adjustment apparatus of claim 9, wherein the receiver circuits of the receiving arrangement include respective directional limiting arrangements configured to limit locations from which the receiver circuits receive the identification signals wirelessly communicated by the transponder.

12. The adjustment apparatus of claim 11, wherein the directional limiting arrangements include respective directional antenna arrangements configured to receive the identification signals wirelessly communicated by the transponder.

13. The adjustment apparatus of claim 1, wherein the processing arrangement is configured to automatically set the user preference of the customizable vehicle component only if at least one external event indicates that a user of the identification device intends to enter the vehicle.

14. The adjustment apparatus of claim 13, wherein the external event includes the activation of an active transponder to communicate a wireless entry intent signal, the receiving arrangement being configured to detect the wireless entry intent signal.

15. The adjustment apparatus of claim 13, wherein the external event includes an insertion of a key into a keyhole receptacle, and the adjustment apparatus further comprises a key insertion detection circuit configured to detect the insertion of the key into the keyhole receptacle, the key insertion detection circuit being further configured to communicate an insertion detect signal to the processing arrangement if the key insertion detection circuit detects the insertion of the key into the keyhole receptacle.

16. The adjustment apparatus of claim 13, wherein the vehicle includes a plurality of doors and at least one door opening device configured to open at least one of the doors, and the external event includes an activation of the door opening device, the adjustment apparatus further comprising an activation detection circuit configured to detect the activation of the door opening device, the activation detection circuit being further configured to communicate an activation detect signal to the processing arrangement if the activation detection circuit detects the activation of the door opening device.

17. The adjustment apparatus of claim 16, wherein the door opening device includes a door handle.

18. The adjustment apparatus of claim 13, wherein the identification device includes a passive transponder, the adjustment apparatus further comprising an interrogation circuit configured to interrogate the passive transponder to cause the passive transponder to wirelessly communicate the identification signals to the receiving arrangement.

19. The adjustment apparatus of claim 18, wherein the interrogation circuit is configured to interrogate the passive transponder when a door opening device is activated.

20. An adjustment apparatus of a vehicle, the apparatus comprising:
at least one customizable vehicle component situated within the vehicle;
a receiving arrangement including a plurality of receiver circuits arranged in the vehicle, the receiver circuits being configured to wirelessly receive identification signals communicated by at least one transponder device, the transponder device having a position with respect to the vehicle; and
a processing arrangement communicatively coupled to the receiving arrangement, the receiving arrangement configured to communicate the identification signals to the processing arrangement;
wherein the processing arrangement is configured to automatically set a user preference of the customizable vehicle component as a function of the identification signals and as a function of which of the receiver circuits receives the identification signals wirelessly communicated by the transponder, the processing arrangement being further configured to automatically set the user preference of the customizable vehicle component only if at least one external event indicates that a user of the transponder device intends to enter the vehicle.

21. The adjustment apparatus of claim 20, wherein the transponder device includes a passive transponder, the adjustment apparatus further comprising an interrogation circuit configured to interrogate the passive transponder to cause the passive transponder to wirelessly communicate the identification signals to the receiving arrangement.

22. The adjustment apparatus of claim 21, wherein the interrogation circuit is configured to interrogate the passive transponder when a door opening device is activated.

23. The adjustment apparatus of claim 21, wherein the interrogation circuit is configured to interrogate the passive transponder when a key is inserted into a keyhole receptacle of the vehicle.

24. The adjustment apparatus of claim 21, wherein the processing arrangement is configured to automatically set the user preference of the customizable vehicle component as a function of a strength of the identification signals wirelessly communicated by the transponder.
